(19) United States
(12) Patent Application Publication
(10) Pub. No.: US 2026/0357546 A1
(43) Pub. Date: Nov. 12, 2026

(54) ATMOSPHERIC WATER GENERATOR

(71) Applicant: University of Northumbria at Newcastle, Newcastle upon Tyne (GB)

(72) Inventors: Ben Bin XU, Newcastle upon Tyne (GB); Muhammad Wakil SHAHZAD, Newcastle upon Tyne (GB)

(73) Assignee: University of Northumbria at Newcastle, Newcastle upon Tyne (GB)

(21) Appl. No.: 19/129,996

(22) PCT Filed: Nov. 15, 2023
(86) PCT No.: PCT/GB2023/052992

§ 371 Date: May 14, 2025

(30) Foreign Application Priority Data
Nov. 16, 2022 (GB) 2217130.0

(51) Int. Cl. E03B 3/28; B01D 53/26; B01D 53/28

(52) U.S. Cl. CPC E03B 3/28; B01D 53/261; B01D 53/28; B01D 2253/108; B01D 2253/116; B01D 2257/80

(57) ABSTRACT

An atmospheric water generator extracts water from atmospheric air. The water generator has an adsorption stage where moisture from input atmospheric air is adsorbed by a water adsorber with adsorbent material. The water generator includes a regeneration stage where the adsorbent material is regenerated by heated air, releasing moisture from the adsorption stage in an output airstream. The water generator includes a water extraction stage where moisture released in the output airstream is collected. The water extraction stage has a heat pump with a cooled element on which moisture in the output airstream condenses, and a heat sink element which discharges thermal energy extracted from the cooled element. The water generator is configured such that the heated air that regenerates the adsorbent material is heated by a combination of thermal energy released from the adsorbent stage and the thermal energy discharged by the heat sink.

### TECHNICAL FIELD

The present invention relates to atmospheric water harvesting. In particular, hybrid atmospheric water harvesting using adsorbent materials combined with an air cooling system.

### BACKGROUND

Access to clean water in certain settings is limited (for example, in arid or remote environments). In addition, natural disasters and contamination events can temporarily interrupt clean water provisions in areas in which there would otherwise be sufficient clean water. Often, clean water is transported to, and stored at, such locations experiencing clean water shortage. Transporting and storing large amounts of water in this way can be impractical and produce substantial carbon emissions.

Atmospheric water generators (AWGs) can be used in such settings to provide an alternative means of producing water by harvesting moisture from air in the atmosphere. Conventional AWGs (i.e. cooling condensation AWGs comprising a compressor, condenser, expansion valve, and evaporator) use evaporators to extract moisture from the air. They do this by reducing the temperature of the air surrounding the evaporator sufficiently to allow it to release water (i.e. reducing the air temperature to below its dew point such to produce condensation). The condensed water is then collected and filtered.

However, performance of cooling condensation AWGs is dependent on the relative humidity of the atmospheric air. For example, it becomes less efficient to extract moisture from air as the relative humidity of that air decreases, because the specific energy input requirements of the cooling condensation AWGs to cool the air sufficiently to release water increase correspondingly.

There are alternative AWGs which comprise desiccant water harvesting systems (in which a stream of ambient air is driven over an adsorbent material configured to adsorb moisture from the ambient air). These AWGs require regeneration which typically involves using a second air stream to desorb the adsorbent material thereby regenerating it to allow further adsorption. This regeneration process is typically ‘passive’ (i.e. no additional heat energy is added to the second stream of air) which limits the water production capacity of such AWGs. An ‘active’ regeneration process can be used instead. However, this requires adding heat energy to the second stream of air. This process can substantially reduce the efficiency of the resulting AWGs.

Therefore, due to low efficiency (due to increased energy requirements) and limited water production capacity (associated with passive regeneration), existing AWGs can be impractical in arid environments in which the air in the atmosphere has a low relative humidity or in environments in which relative humidity substantially fluctuates.

### SUMMARY OF THE INVENTION

In accordance with a first aspect of the invention, there is provided an atmospheric water generator for extracting water from atmospheric air, the atmospheric water generator comprising: an adsorption stage where moisture from input atmospheric air is adsorbed by a water adsorber comprising adsorbent material; a regeneration stage where the adsorbent material of the water adsorber is regenerated by heated air such that moisture adsorbed by the adsorption stage is released in an output airstream; and a water extraction stage where moisture released in the output airstream from the regeneration stage is collected, said water extraction stage comprising a heat pump comprising: a cooled element on which moisture in the output airstream from the regeneration stage condenses, and a heat sink element configured to discharge thermal energy extracted from the cooled element, wherein the atmospheric water generator is configured such that the heated air that regenerates the adsorbent material of the water adsorber at the regeneration stage is heated by a combination of thermal energy released from the adsorbent stage and the thermal energy discharged by the heat sink.

Optionally, in use, relative to the adsorption stage and the regeneration stage, the adsorbent material cycles between a first position where it is exposed to the adsorption stage and a second position where it is exposed to the regeneration stage.

Optionally, the adsorbent material cycles between the first position and the second position by virtue of the water adsorber rotating relative to the adsorption stage and the regeneration stage.

Optionally, the water adsorber is configured such that, in use a first portion of the adsorbent material is exposed to the input atmospheric air of the adsorption stage whilst a second portion of the adsorbent material is exposed to the heated air of the regeneration stage, and as the water adsorber rotates, the first portion and second portion continuously exchange positions, such that the adsorption stage and the regeneration stage operate continuously.

Optionally, the water adsorber is formed by the adsorbent material which is substantially disc shaped.

Optionally, the first portion is a sector of the disc comprising approximately two thirds of the surface area of the disc; and the second portion is a sector of the wheel comprising approximately one third of the surface area of the disc.

Optionally, the atmospheric water generator further comprises a motor for rotating the water adsorber, a control unit, and a humidity sensor configured to measure humidity of the input atmospheric air, wherein the humidity sensor is configured to generate and communicate to the control unit a humidity sensor signal indicative of the humidity of the input atmospheric air, and the control unit is configured to control the speed of the motor in accordance with the detected humidity level such that the greater the humidity of the input air, the greater the rotational frequency of the water adsorber.

Optionally, the atmospheric water generator further comprises a fan configured to drive the input atmospheric air over the water adsorber in the adsorption stage.

Optionally, the cooled element of the heat pump is an evaporator; the heat sink of the heat pump is a condenser; and the heat pump further comprises a compressor and an expansion valve, wherein the heat pump is configured to implement a refrigeration cycle to cool the evaporator such that moisture in the output airstream from the regeneration stage condenses thereon.

Optionally, the water adsorber is configured to rotate within a range of approximately 2 rpm to 10 rpm.

Optionally, the atmospheric water generator further comprises a power supply, the power supply configured to provide power to components of the atmospheric water generator.

Optionally, the power supply is a renewable energy source.

Optionally, the renewable energy source is a solar energy source.

Optionally, the renewable energy source is a wind energy source.

Optionally, the power supply is any of: a generator, a fuel cell, or a battery.

Optionally, the atmospheric water generator further comprises an energy storage means configured to store excess energy provided by the power supply.

Optionally, the adsorbent material is provided by silica gel.

Optionally, the adsorbent material is provided by a zeolite or a molecular sieve.

Optionally, the relative humidity of the output airstream is greater than 90%.

In accordance with a second aspect of the invention there is provided a method of extracting moisture from air using an atmospheric water generator in accordance with the first aspect, the method comprising: passing input atmospheric air through the adsorption stage such that moisture from the input atmospheric air is adsorbed by the adsorber; heating the air output from the adsorption stage using a combination of thermal energy released from the adsorbent stage and the thermal energy discharged by the heat sink; passing the heated air through the regeneration stage such that moisture adsorbed by the adsorption stage is released in the output airstream; and cooling the cooled element of the heat pump sufficiently such that moisture in the output airstream from the regeneration stage condenses and collects thereon.

In accordance with embodiments of the invention there is provided an atmospheric water generator for extracting water from atmospheric air. The atmospheric water generator comprises an adsorbent material along with components of a conventional atmospheric water generator (such as, a cooled element and a heat sink). The adsorbent material is configured to adsorb moisture from an atmospheric airstream. A heated airstream is used to regenerate the adsorbent material thereby releasing the adsorbed moisture into the heated airstream to produce a humid airstream. The humid airstream is subsequently passed over the cooled element. The heat sink and the adsorbent material are arranged with respect to one another such that the energy required to heat the heated airstream is provided by heat produced by the process of adsorption (from the adsorbent material adsorbing moisture from the atmospheric airstream) and heat rejected by the heat sink.

Advantageously, arranging the components with respect to one another in this way increases efficiency of the atmospheric water generator. This is because heat energy (that would otherwise be wasted) is used instead of an additional energy source that would otherwise be required to heat the air prior to use for regeneration. As such, the resulting atmospheric water generator can produce more water per unit of energy/cost than conventional atmospheric water generators.

In accordance with certain embodiments of the invention, in use, the adsorbent material is continuously rotated such that a first portion of the adsorbent material is exposed to input atmospheric air whilst a second portion of the adsorbent material is exposed to the heated air used for regeneration. Advantageously, as the adsorbent material rotates, the first portion and second portion continuously exchange positions, such that the adsorbent material is both adsorbing and being regenerated continuously.

In accordance with certain embodiments of the invention, the rotational frequency with which the adsorbent material is rotated is dependent on the relative humidity of the atmospheric airstream such that the greater the relative humidity of the atmospheric air, the greater the rotational frequency of the adsorbent material. Advantageously, in this way, the rotational frequency of the adsorbent material is optimised to take into account the dependency of adsorption rates on the relative humidity of the input air. For example, when the relative humidity of the atmospheric airstream increases, a higher rotational frequency of the adsorbent material is required to avoid over saturation of the adsorbent material. Conversely, when the relative humidity of the atmospheric airstream decreases, a lower rotational frequency of the adsorbent material is required to ensure sufficient moisture is adsorbed by the adsorbent material from the atmospheric airstream. Further, optimising the rotational frequency of the adsorbent material in this way maintains a high relative humidity in the humid airstream irrespective of fluctuations in relative humidity of the input atmospheric air. Therefore, performance of the cooled element is de-coupled from fluctuations in relative humidity of input atmospheric air.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1a provides a simplified schematic diagram of a conventional condensing-type atmospheric water generator;

FIG. 1b provides a simplified schematic diagram depicting work input and thermodynamic operation of the conventional condensing-type atmospheric water generator shown in FIG. 1a, and

FIG. 2 provides a simplified schematic diagram depicting an atmospheric water generator arranged in accordance with certain embodiments of the invention.

### DETAILED DESCRIPTION

### Prior Art

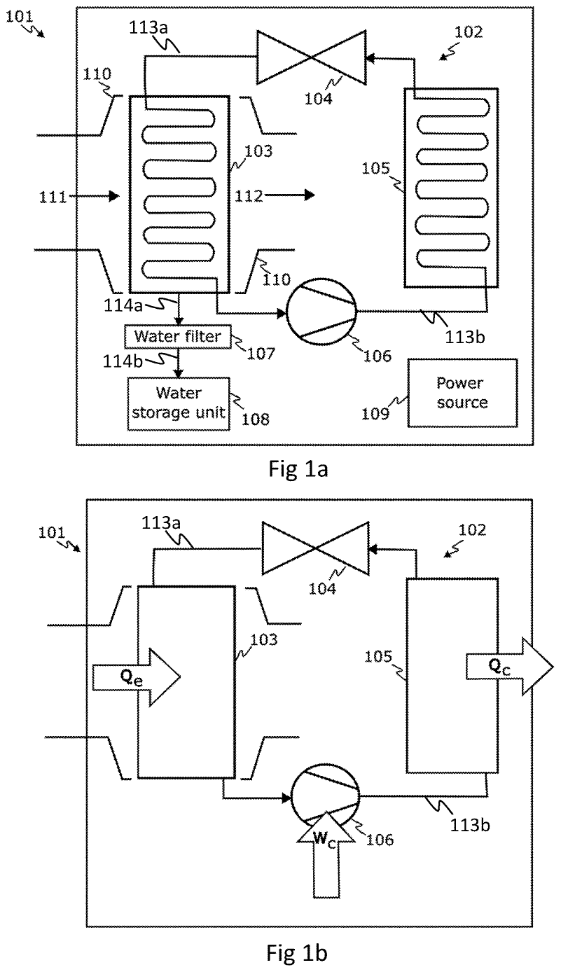

FIG. 1a provides a simplified schematic diagram of a conventional (condensing-type) atmospheric water generator 101.

The conventional atmospheric water generator 101 comprises a heat pump 102, a water filter 107, a water storage unit 108, and a power source 109. The heat pump 102 comprises an evaporator 103, an expansion valve 104, a condenser 105, and a compressor 106.

The conventional atmospheric water generator 101 is configured to extract water from atmospheric input air 111 by reducing the temperature of the atmospheric input air 111 to below its ‘dew point’ such that moisture vapour in the air condenses into water droplets which collect on an external surface of the evaporator and 103. The water droplets are subsequently fed to the water storage unit 108 where the collected water is stored.

To reduce the temperature of the atmospheric input air 111, the heat pump 102 performs a vapour-compression refrigeration cycle in which a refrigerant is circulated through the heat pump 102 in the direction shown by arrows 113a and 113b. This process is described in more detail, as follows.

In the vapour-compression refrigeration cycle, the compressor 106 (powered by the power source 109) compresses the refrigerant (which is in gaseous form) thereby increasing its temperature and pressure. The refrigerant (in compressed gaseous form) exits the compressor 106 and enters the condenser 105. The condenser 105 discharges heat from the refrigerant contained therein to the environment in which the condenser 105 is located (thereby condensing the refrigerant). The refrigerant (in condensed form) exits the condenser 105 and enters the expansion valve 104. The expansion valve 104 expands the refrigerant reducing the pressure of the refrigerant sufficiently that the temperature of the refrigerant reduces below the temperature of the atmospheric input air 111. The cooled refrigerant exits the expansion valve 104 and enters the evaporator 103 thereby cooling the evaporator 103 to a temperature below that of the atmospheric input air 111.

Contemporaneously, the atmospheric input air 111 is passed over the evaporator 103, via ductwork 110 (for example, by using a fan configured to drive the atmospheric input air 111 through the ductwork 110). As the evaporator 103 is cool relative to the atmospheric input air 111, heat is transferred from the atmospheric input air 111 to the evaporator 103 and the refrigerant contained therein. This causes the refrigerant to evaporate and moisture vapour in the atmospheric input air 111 to condense into water droplets which collect on an external surface of the evaporator 103. These droplets are subsequently fed through piped connections (in the direction shown by arrows 114a and 114b), via the water filter 107, to the water storage unit 108 where the water is stored. Cooled air 112 is exhausted away from the evaporator 103.

FIG. 1b provides a simplified schematic diagram depicting work input and thermodynamic operation of the conventional atmospheric water generator 101.

As can be seen in FIG. 1b, the compressor 106 performs work ‘W_{c}’ on the refrigerant thereby introducing energy into the heat pump system; the condenser 105 subsequently discharges waste heat energy ‘Q_{c}’ to the environment in order to condense the refrigerant contained therein; and, the evaporator 103 absorbs heat energy ‘Qₑ’ from the atmospheric input air 111.

### Components of the Atmospheric Water Generator

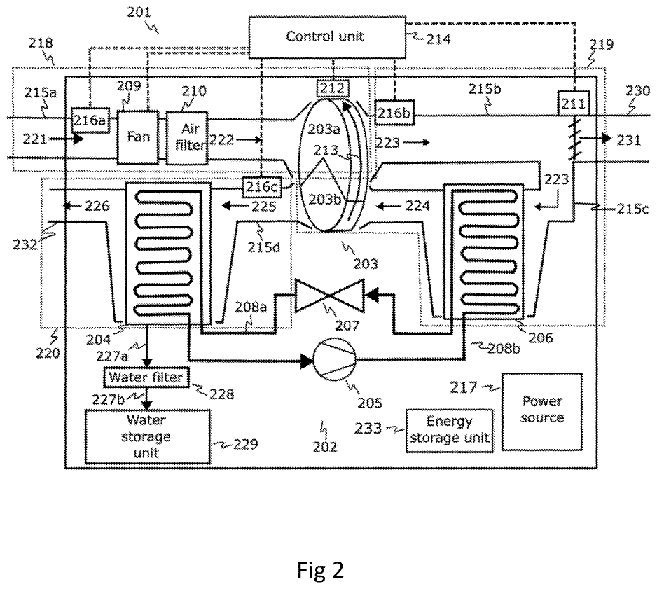

FIG. 2 provides a simplified schematic diagram depicting an atmospheric water generator 201 arranged in accordance with certain embodiments of the invention.

The atmospheric water generator 201 comprises a heat pump 202 (comprising an evaporator 204, a compressor 205, a condenser 206, and an expansion valve 207) which is configured to extract water from air in the same way as that described with reference to the heat pump 102. However, the atmospheric water generator 201 further comprises a desiccant wheel 203 which is configured to adsorb moisture from atmospheric air. The desiccant wheel 203 comprises a disc of adsorbent material (for example, a silica gel, a zeolite molecular sieve, or a metal-organic framework).

The atmospheric water generator 201 further comprises ductwork 215a configured to guide input atmospheric air over a first portion 203a (which is a sector representing approximately two thirds of the surface area of the desiccant wheel 203). The first portion 203a is configured to adsorb moisture from the input air. The atmospheric water generator 201 further comprises ductwork 215b configured to guide air exhausted from the first portion 203a away from the first portion 203a. The atmospheric water generator 201 further comprises ductwork 215c configured to guide the exhausted air over the condenser 206 and subsequently over a second portion 203b (which is a sector representing approximately one third of the surface area of the desiccant wheel 203). The condenser 206 is configured to transfer heat to the exhausted air before it passes over the second portion 203b. The second portion 203b is configured to be regenerated by the exhaust air. The atmospheric water generator 201 further comprises ductwork 215d configured to guide air exhausted from the second portion 203b over the evaporator 204 such that water (adsorbed by the first portion 203a) can be extracted from the exhausted air by the evaporator 204. The atmospheric water generator 201 further comprises a valve 211 configured to direct exhausted air from the ductwork 215b to the ductwork 215c.

The atmospheric water generator 201 further comprises a fan 209 configured to drive input atmospheric air, through ductwork 215a 215b 215c 215d via an air filter 210 configured to filter the air.

The atmospheric water generator 201 further comprises: a motor 212 configured to rotate the desiccant wheel 203 in the direction indicated by arrow 213; a control unit 214 configured to control the rotational frequency of the motor 212 (and therefore the rotational frequency of the desiccant wheel 203); and, sensors 216a 216b 216c configured to measure the absolute and relative humidity of the air contained in ductwork 215a, 215b, and 215d, respectively. The sensors 216a 216b 216c are further configured to generate and send sensor signals corresponding to the measured absolute and relative humidity in each respective ductwork to the control unit 214.

The atmospheric water generator 201 further comprises a power source 217 and an energy storage unit 233. Typically, the power source 217 is a solar power source configured to provide power to components of the atmospheric water generator 201 (such as, the fan 209, the control unit 214, the compressor 205, and the motor 212). The energy storage unit 233 is configured to store excess energy provided by the power source 217.

Together, the ductwork 215a, the fan 209, air filter 210, and the first portion 203a form an adsorption stage 218 in which moisture from input air is adsorbed by the first portion 203a. Together, the ductwork 215b 215c, the valve 211, the condenser 206, and the second portion 203b form a regeneration stage 219 in which the second portion 203b is regenerated by heated air such that moisture adsorbed in the adsorption stage 218 is released into an output airstream. Together, the ductwork 215d and the evaporator 204 form a water extraction stage 220 in which moisture released in the output airstream from the regeneration stage 219 is collected. The components of the adsorption stage 218, the regeneration stage 219, and the water extraction stage 220 are outlined approximately, with dotted lines, in FIG. 2.

### Operation of the Atmospheric Water Generator

Broadly, in use, the desiccant wheel 203 adsorbs moisture from an input atmospheric airstream. A heated airstream is then used to actively regenerate the desiccant wheel 203 thereby releasing the desorbed moisture into an output airstream which is subsequently passed over the evaporator 204 of the heat pump 202. The output airstream is a humid airstream. That is, the output airstream contains moisture adsorbed by the desiccant wheel 203, therefore, the relative humidity of the output airstream is higher than that of the input atmospheric airstream. Therefore, more moisture can be condensed from the output airstream than would be condensed from the input atmospheric airstream (in the absence of the desiccant wheel 203). Further, using the desiccant wheel 203 in this way de-couples the performance of the evaporator 204 from the relative humidity of the atmospheric air by producing an output airstream which is of high relative humidity relative to that of the atmospheric air.

Further, the heat pump 202 and the desiccant wheel 203 are arranged such that the energy required to heat the heated airstream is provided by heat produced by the process of adsorption (from the desiccant wheel 203 adsorbing moisture from the input atmospheric airstream) and heat from the condenser 206 (which would otherwise be wasted (like Q_{c} in FIG. 1b)). Advantageously, this increases efficiency of the atmospheric water generator 201 because otherwise an additional energy source would be required to heat the air prior to use for regeneration. Operation of the atmospheric water generator is described in more detail as follows.

The fan 209 drives input atmospheric air 221 through the respective ductworks 215a 215b 215c 215d (and in the process, through the adsorption stage 218, the regeneration stage 219, and into the water extraction stage 220) to produce an output airstream 225. Under normal operating conditions, the temperature and relative humidity of input atmospheric air 221 can vary but are typically from 28C to 40C and 40% to 90%, respectively. The output airstream 225 is of a higher temperature and relative humidity than the input atmospheric air 221 (typically in the range of 40C to 50C and 85% to 95%, respectively (preferably the temperature is around 40C and the relative humidity is at least around 95%). Whilst the fan 209 is driving the air through the respective ductworks 215a 215b 215c 215d, the heat pump 202 contemporaneously performs a refrigeration cycle (in which a refrigerant is circulated through the heat pump 202 in the direction shown by arrows 208a and 208b) to cool the evaporator 204 to a temperature which is below that of the output airstream 225 such that it can extract moisture from the output airstream 225.

Whilst the atmospheric water generator 201 is in use, the motor 212 under the control of the control unit 214 is configured to rotate the desiccant wheel 203 in direction 213 such that the first portion 203a and the second portion 203b continuously exchange positions thereby cyclically exposing the adsorbent material of the desiccant wheel 203 to the filtered input atmospheric air 222 of the adsorption stage 218 and the heated exhaust air 224 of the regeneration stage 219. In this way, the adsorption stage 218 and the regeneration stage 219 operate continuously.

Further, the control unit 214 controls the rotational frequency of the motor 212 (and therefore the desiccant wheel 203) in accordance with the detected humidity (either relative, absolute, or both) of the input atmospheric air 221 such that the greater the humidity of the input air, the greater the rotational frequency of the desiccant wheel 203. Typically, the motor is configured to rotate the desiccant wheel 203 within a range of 2 rpm to 10 rpm. Though, other rotational frequencies can be used.

Advantageously, in this way, the rotational frequency of the desiccant wheel 203 is optimised to take into account the dependency of adsorption rates on the humidity of the input air. For example, when the humidity of the input atmospheric air 221 increases, a higher rotational frequency of the desiccant wheel 203 is required to avoid over saturation of the adsorbent material. Conversely, when the humidity of the input atmospheric air 221 decreases, a lower rotational frequency of the desiccant wheel 203 is required to ensure sufficient moisture is adsorbed by the desiccant wheel 203 from the input atmospheric air 221. Further, optimising the rotational frequency of the desiccant wheel 203 in this way maintains a high humidity in the output airstream irrespective of fluctuations in humidity of the input atmospheric air 221. Therefore, performance of the evaporator 204 is de-coupled from fluctuations in humidity of input atmospheric air 221.

The water extraction process is described in more detail, as follows.

Under the control of the control unit 214, the fan 209 drives input atmospheric air 221, within ductwork 215a, through the air filter 210 thereby producing filtered input atmospheric air 222 which is passed over the first portion 203a.

As the filtered input atmospheric air 222 is passed over the first portion 203a, the adsorbent material from which the first portion 203a is comprised adsorbs moisture from the filtered input atmospheric air 222. The adsorption process reduces the relative humidity, and increases the temperature, of the filtered input atmospheric air 222.

Exhaust air 223 (of lower relative humidity and higher temperature than the filtered input atmospheric air 222) exits the first portion 203a into the ductwork 215b.

The performance of the adsorbent material, from which the desiccant wheel 203 is comprised, is gauged by comparing the humidity of the exhaust air 223 relative to input atmospheric air 221. That is, where the humidity measured by the sensor 216b is low relative to the humidity measured by the sensor 216a then the adsorbent material is performing well. Conversely, where the humidity measured by the sensor 216b is not low relative to the humidity measured by the sensor 216a then the adsorbent material is not performing well. It will be understood that the sensor 216a could instead be located after the fan 209 and the air filter 210 such that the sensor 216a is configured to measure the humidity of the filtered input atmospheric air 222.

The control unit 214 controls the valve 211 to direct an amount the exhaust air 223 from the ductwork 215b into the ductwork 215c and to direct an amount of excess exhaust air 231 out of the atmospheric water generator 201 via an exhaust 230. The amount of exhaust air 223 which is directed from the ductwork 215b into the ductwork 215c is dependent on the relative humidity of the output airstream 225. In particular, the control unit 214 is configured to control the valve 211 in accordance with the relative humidity measured by the sensor 216c such that the relative humidity in the output airstream 225 is maintained within a predetermined range. As such, when the relative humidity of the output airstream 225 decreases, the amount of exhaust air 223 which is directed from the ductwork 215b into the ductwork 215c decreases correspondingly in order to maintain a relative humidity in the output airstream 225 within the predetermined range. Conversely, when the relative humidity of the output airstream 225 increases, the amount of exhaust air 223 which is directed from the ductwork 215b into the ductwork 215c increases correspondingly to maintain a relative humidity in the output airstream 225 within the predetermined range. A typical predetermined range for the relative humidity of the output airstream is 85 to 90% but it will be understood that this range can comprise lower and higher bounds.

The exhaust air 223 that is directed into the ductwork 215c is subsequently passed over the condenser 206 which transfers heat energy to the exhaust air 223 thereby producing heated exhaust air 224.

The heated exhaust air 224 is passed over the second portion 203b during which moisture adsorbed by the adsorption stage is released in the output airstream 225, thereby regenerating the second portion 203b.

The output airstream 225 is passed over the cooled evaporator 204. During which, moisture from the output airstream 225 condenses into water droplets which collect on an external surface of the evaporator 204. These are subsequently fed through piped connections (in the direction shown by arrows 227a and 227b), via water filter 228, to a water storage unit 229 where the water is stored for subsequent use. It will be understood that the water can be fed via the piped connections by any suitable means of moving the water, for example, gravity or a pump system. Cooled air 226 is exhausted away from the evaporator 204 via an exhaust 232.

Advantageously, by arranging the atmospheric water generator 201 as described above, the evaporator 204 is fed air (the output airstream 225) which is of high humidity relative to the input atmospheric air (by virtue of the output airstream containing moisture adsorbed by the desiccant wheel 203). Therefore, more moisture can be condensed from the output airstream 225 than would be condensed from the input atmospheric airstream (in the absence of the desiccant wheel 203). Further, using the desiccant wheel 203 in this way de-couples the performance of the evaporator 204 from the relative humidity of the atmospheric air by producing an output airstream which is of high relative humidity relative to that of the atmospheric air.

As described above, the exhaust air 223 is heated by both the process of adsorption (from the adsorption stage 218) and heat from the condenser 206 (from the regeneration stage 219) which would otherwise be waste heat (as is the case with Q_{c} described with reference to the heat pump 102). Advantageously, using the heat of adsorption and heat from the condenser increases the efficiency of the atmospheric water generator 201 because otherwise an additional energy source would be required to heat the air prior to use for regeneration.

Therefore, by combining the above systems and using heat energy that would otherwise be wasted, the resulting system can produce more water per unit of energy/cost than conventional AWGs.

In the above embodiment, the first portion of the desiccant wheel (configured to adsorb moisture from the atmospheric air) is a sector representing approximately two thirds of the surface area of the desiccant wheel and the second portion of the desiccant wheel (configured to be desorbed by the heated airstream) is a sector representing approximately one third of the surface area of the desiccant wheel. However, different proportions can be used for the first portion and the second portion provided the desiccant wheel can sufficiently adsorb and desorb moisture during operation (such that the output air stream is of a higher relative humidity that the input atmospheric air), without becoming saturated.

In the above embodiment, a desiccant wheel comprising a disc of adsorbent material is used to adsorb moisture from input atmospheric air. However, adsorbent material formed into other shapes can be used in place of the desiccant wheel provided it can adsorb moisture from input atmospheric air which can subsequently be desorbed into an output airstream.

In the above embodiment, the desiccant wheel is configured to continuously rotate in a single direction within a frequency range of 2 rpm to 10 rpm. However, the desiccant wheel can be configured instead, for example: to rotate according to a duty cycle; or, rotate in an alternate direction; or, alternate between rotational directions etc.; provided the adsorbent material can sufficiently adsorb moisture from input atmospheric air which can subsequently be desorbed into an output airstream (such that the output air stream is of a higher relative humidity that the input atmospheric air).

In the above embodiment, the power source is a solar power source. However, power can be provided by alternative power sources such as: a wind energy source, a generator, a fuel cell, a battery, or a connection to the grid.

In the above embodiment, a heat pump is used to extract water from atmospheric air by performing a vapour-compression refrigeration cycle to reduce the temperature of the atmospheric input air such that water vapour therein condenses. The heat pump is a heat transfer system comprising a cooled element (the evaporator) for cooling air and a heat sink (the condenser) for removing heat (i.e. thermal energy) from the heat pump system. It will be understood that alternative heat transfer systems could be used in place of the heat pump described with reference to the above embodiment provided these systems can cool the output airstream sufficiently to condense water vapour therein and exhaust heat to heat the stream of air which is used to regenerate the desiccant wheel. For example, adsorbent heat transfer systems, absorbent heat transfer systems, or thermoelectric heat transfer systems.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. An atmospheric water generator for extracting water from atmospheric air, the atmospheric water generator comprising:
an adsorption stage where moisture from input atmospheric air is adsorbed by a water adsorber comprising adsorbent material;
a regeneration stage where the adsorbent material of the water adsorber is regenerated by heated air such that moisture adsorbed by the adsorption stage is released in an output airstream; and
a water extraction stage where moisture released in the output airstream from the regeneration stage is collected, said water extraction stage comprising a heat pump comprising:
a cooled element on which moisture in the output airstream from the regeneration stage condenses, and
a heat sink element configured to discharge thermal energy extracted from the cooled element, wherein
the atmospheric water generator is configured such that the heated air that regenerates the adsorbent material of the water adsorber at the regeneration stage is heated by a combination of thermal energy released from the adsorption stage and the thermal energy discharged by the heat sink.

2. An atmospheric water generator according to claim 1, wherein
in use, relative to the adsorption stage and the regeneration stage, the adsorbent material cycles between a first position where it is exposed to the adsorption stage and a second position where it is exposed to the regeneration stage.

3. An atmospheric water generator according to claim 2, wherein the adsorbent material cycles between the first position and the second position by virtue of the water adsorber rotating relative to the adsorption stage and the regeneration stage.

4. An atmospheric water generator according to claim 3, wherein the water adsorber is configured such that, in use
a first portion of the adsorbent material is exposed to the input atmospheric air of the adsorption stage whilst a second portion of the adsorbent material is exposed to the heated air of the regeneration stage, and
as the water adsorber rotates, the first portion and second portion continuously exchange positions, such that the adsorption stage and the regeneration stage operate continuously.

5. An atmospheric water generator according to claim 4, wherein the water adsorber is formed by the adsorbent material which is substantially disc shaped.

6. An atmospheric water generator according to claim 5, wherein
the first portion is a sector of the disc comprising approximately two thirds of the surface area of the disc; and
the second portion is a sector of the wheel comprising approximately one third of the surface area of the disc.

7. An atmospheric water generator according to claim 3, wherein the atmospheric water generator further comprises a motor for rotating the water adsorber, a control unit, and a humidity sensor configured to measure humidity of the input atmospheric air, wherein
the humidity sensor is configured to generate and communicate to the control unit a humidity sensor signal indicative of the humidity of the input atmospheric air, and
the control unit is configured to control the speed of the motor in accordance with the detected humidity level such that the greater the humidity of the input air, the greater the rotational frequency of the water adsorber.

8. An atmospheric water generator according to claim 1, wherein the atmospheric water generator further comprises a fan configured to drive the input atmospheric air over the water adsorber in the adsorption stage.

9. An atmospheric water generator according to claim 1, wherein
the cooled element of the heat pump is an evaporator;
the heat sink of the heat pump is a condenser; and
the heat pump further comprises a compressor and an expansion valve, wherein
the heat pump is configured to implement a refrigeration cycle to cool the evaporator such that moisture in the output airstream from the regeneration stage condenses thereon.

10. An atmospheric water generator according to claim 3, wherein the water adsorber is configured to rotate within a range of approximately 2 rpm to 10 rpm.

11. An atmospheric water generator according to claim 1, wherein the atmospheric water generator further comprises a power supply, the power supply configured to provide power to components of the atmospheric water generator.

12. An atmospheric water generator according to claim 11, wherein the power supply is a renewable energy source.

13. An atmospheric water generator according to claim 12, wherein the renewable energy source is a solar energy source.

14. An atmospheric water generator according to claim 12, wherein the renewable energy source is a wind energy source.

15. An atmospheric water generator according to claim 11, wherein the power supply is any of: a generator, a fuel cell, or a battery.

16. An atmospheric water generator according to claim 11, wherein the atmospheric water generator further comprises an energy storage means configured to store excess energy provided by the power supply.

17. An atmospheric water generator according to claim 1, wherein the adsorbent material is provided by silica gel.

18. An atmospheric water generator according to claim 1, wherein the adsorbent material is provided by a zeolite or a molecular sieve.

19. An atmospheric water generator according to claim 1, wherein a the relative humidity of the output airstream is greater than 90%.

20. A method of extracting moisture from air using an atmospheric water generator according to claim 1, the method comprising:
passing input atmospheric air through the adsorption stage such that moisture from the input atmospheric air is adsorbed by the water adsorber;
heating the air output from the adsorption stage using a combination of thermal energy released from the adsorbent stage and the thermal energy discharged by the heat sink;
passing the heated air through the regeneration stage such that moisture adsorbed by the adsorption stage is released in the output airstream; and
cooling the cooled element of the heat pump sufficiently such that moisture in the output airstream from the regeneration stage condenses and collects thereon.
